(19) United States
(12) Patent Application Publication
(10) Pub. No.: US 2007/0298402 A1
(43) Pub. Date: Dec. 27, 2007

(54) System and method for providing educational course data

(76) Inventors: Lin Zhou, Hockessin, DE (US); Margaret Lee Munkittrick, Towanda, PA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/450,712

(22) Filed: Jun. 9, 2006

(51) Int. Cl. G09B 3/00

(52) U.S. Cl. 434/350

(57) ABSTRACT

A system and method for providing educational course data includes receiving identification data of a first educational course of a first educational institution from a client machine and retrieving educational course equivalency data from a database based on the identification data. The educational course equivalency data is transmitted to the client machine. The educational course equivalency data may include identification data of a second educational course of a second educational institution. The educational course equivalency data may indicate that the first and second educational courses are directly equivalent. The method may also include retrieving course information related to the second educational course based on a request and transmitting the course information to the client machine.

### CROSS-REFERENCE TO RELATED U.S. PATENT APPLICATION

Cross-reference is made to U.S. Utility patent application Ser. No. ______ entitled “System and Method for Managing Educational Courses,” which was filed Jun. 9, 2006 by Lin Zhou et al., the entirety of which is expressly incorporated herein by reference.

### TECHNICAL FIELD

The present disclosure relates generally to systems and methods for managing educational courses from a number of educational institutions.

### BACKGROUND

Educational institutions, such as universities, high schools, and other educational entities, offer a variety of educational courses for students. Because of the differences and typical lack of inter-communication between the educational institutions, it is difficult for students and staff to determine if a course offered by another educational institution is accepted, or should be accepted, as an equivalent course by their present educational institution. Currently such educational course equivalencies are obtained by manually comparing the course descriptions and other information provided in a course catalog or the like from each educational institution. Once a course is selected as an acceptable equivalent course, such suggested course equivalency is manually submitted to a decision maker, such as a department chairperson, a committee, or the like who is responsible for reviewing course equivalencies. If the decision maker decides to accept the course equivalency, the course equivalency must be manually established by, for example, updating the educational institution's database and/or spreadsheet. Further, even once a course equivalency has been established, the course equivalency must be monitored over time, which may be difficult if the educational institution is not aware of updates or changes to accepted equivalent course or if new or updated course catalogs from each educational institution are not otherwise available.

### SUMMARY

According to one aspect, a method for managing educational courses may include receiving identification data of a first educational course of a first educational institution from a client machine. The identification data may be received over a network such as a publicly-accessible, global network (e.g., the Internet). The identification data may include a name, course number, or other identifier of the first educational course. The method may also include retrieving educational course equivalency data from a database based on the identification data. The educational course equivalency data may include identification data of a second educational course of a second educational institution. The second educational course may be directly equivalent to the first educational course and may thereby be accepted by the first educational institution as an equivalent course to the first educational course. Additionally or alternatively, the first educational course may be accepted by the second educational institution as an equivalent course to the second educational course. The method may further include transmitting the educational course equivalency data to the client machine. For example, the identification data, such as the name, course number, or other identifier, of the second educational course may be transmitted to the client machine.

The method may also include receiving a request for course information of the second educational course from the client machine, retrieving the course information from the database based on the request, and transmitting the course information of the second educational course to the client machine. In some embodiments, a request for course information may also be transmitted to the second educational institution based on the request received from the client machine. In such embodiments, course information may be received from the second institution, such as from a client machine of the second institution, and subsequently transmitted to the client machine of the first institution. In this way, course information may be obtained from the database and/or from the second institution.

According to another aspect, a system for managing educational courses may include a processor and a memory device. The memory device may be electrically coupled to the processor and may have therein a plurality of instructions, which when executed by the processor, cause the processor to receive identification data of a first educational course of a first educational institution from a client machine. The identification data may be received over a network such as a publicly-accessible, global network (e.g., the Internet). The identification data may include a name, course number, or other identifier of the first educational course. The plurality of instructions may also cause the processor to retrieve educational course equivalency data from a database based on the identification data. The educational course equivalency data may include identification data of a second educational course of a second educational institution. The second educational course may be accepted by the first educational institution as an equivalent course to the first educational course. Additionally or alternatively, the first educational course may be accepted by the second educational institution as an equivalent course to the second educational course. The plurality of instructions may further cause the processor to transmit the educational course equivalency data to the client machine. For example, the identification data, such as the name, course number, or other identifier, of the second educational course may be transmitted to the client machine. The plurality of instructions may further cause the processor to receive a request for course information of the second educational course from the client machine, retrieve the course information from the database based on the request, and transmit the course information of the second educational course to the client machine.

According to a further aspect, a method for providing educational course data may include retrieving first identification data of a first educational course of a first educational institution from a database. The method may also include retrieving second identification data of a second educational course of a second educational institution from the database. The first identification data and/or the second identification data may include a course number, a course title, a course subject, and/or the like. The method may also include transmitting the first identification data and the second identification data to a client machine over a network. The method may further include receiving third identification data of a third educational course of a third educational institution from the client machine. The first identification data and the second identification data may be retrieved from the database based on the third identification data. In some embodiments, the first educational course and/or the second educational course may be directly equivalent to the third educational course. For example, the first educational course and/or the second educational course may be accepted by the third educational institution as an equivalent course to the third educational course.

### BRIEF DESCRIPTION OF THE DRAWINGS

The detailed description particularly refers to the following figures, in which:

FIG. 1 is a simplified block diagram of a system for managing educational courses;

FIG. 2 is a simplified flowchart of an algorithm for reviewing equivalent courses used by the system of FIG. 1;

FIG. 3 is a simplified flowchart of an algorithm for managing educational courses used by the system of FIG. 1

FIG. 4 is a algorithm for determining educational course equivalencies used by the system of FIG. 1; and

FIGS. 5-12 are screenshots that are displayed on a display device of the system of FIG. 1 during the execution of the algorithms of FIG. 2 and/or 3.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

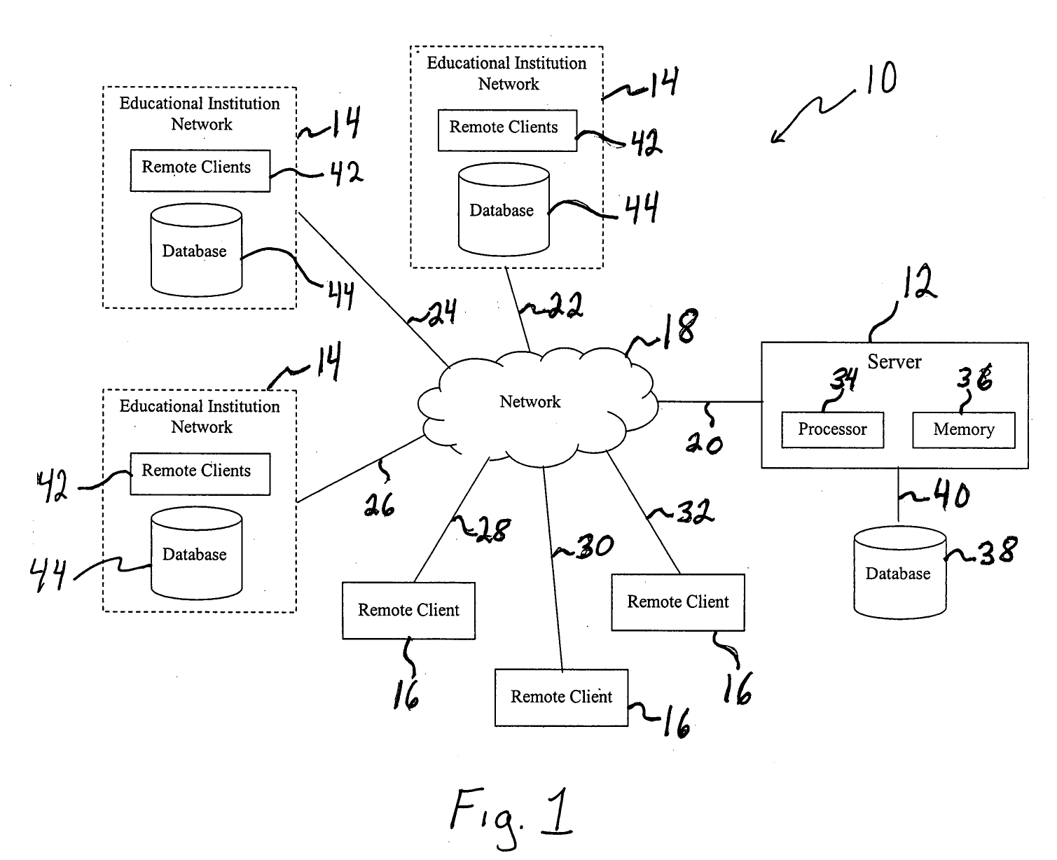

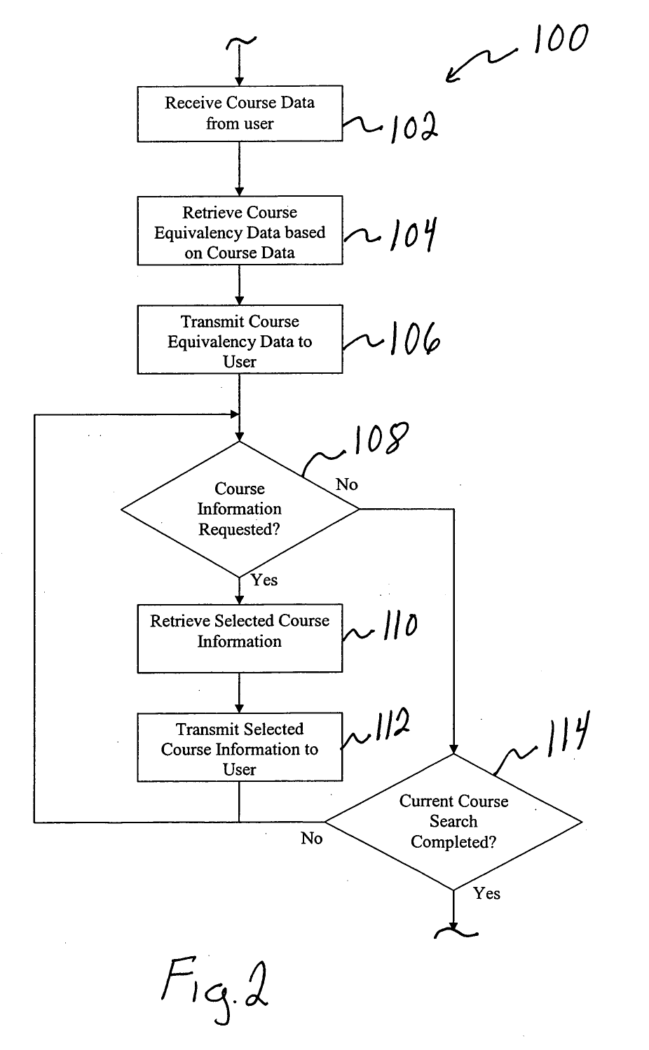

Referring now to FIG. 1, a system 10 for managing a number of educational courses includes a server 12, a number of educational institution networks 14, and a number of remote clients 16. The server 12, educational institution networks 14, and remote clients 16 are communicatively coupled to each other via a communication network 18 and a number of communication links 20, 22, 24, 26, 28, 30, 32. The network 18 may be embodied as any type of communication network capable of providing communication between the server 12 and the educational institution networks 14 and the remote clients 16. For example, the network 16 may be embodied as a wide area network (WAN), a local area network (LAN), or form a portion of a publicly-accessible, global network such as, for example, the Internet. In addition, the network 18 may be a wired network, a wireless network, or a combination thereof As such, the network 18 may include any number of devices for providing communication between the server 12 and the educational institution networks 14 and the remote clients 16 such as routers, switches, computers, communication links, and the like. Similarly, the communication links 20, 22, 24, 26, 28, 30, 32 may be embodied as any type of communication links capable of providing communication between the server 12 and the educational institution networks 14 and the remote clients 16. For example, the communication links 20, 22, 24, 26, 28, 30, 32 may be embodied as any number of cables, wires, fiber optic cables, wireless signals, and/or the like.

The server 12 may be embodied as one or more computers and/or computing devices and associated networks and/or other devices capable such that the server 12 is capable of communicating with the educational institution networks 14 and/or the remote clients 16 via the network 18. The illustrative server 12 includes one or more processors 34 and one or more memory device 36. The processor 34 may be embodied as any type of processor including, for example, discrete processing circuitry (e.g., a collection of logic devices), general purpose integrated circuit(s), and/or application specific integrated circuit(s) (i.e., ASICs). The memory device 36 may be embodied as any type of memory device and may include one or more memory types, such as, random access memory (i.e., RAM) and/or read-only memory (i.e., ROM). In addition, the server may include other devices and circuitry typically found in a computer for performing the functions described herein such as, for example, a hard drive, a display and associated driver circuitry, input/output circuitry, and the like.

The server 12 is communicatively coupled to a database 38 via a communication link 40. The database 38 may be embodied as any type of database capable of storing an educational course equivalency data and information related to educational courses. For example, the database 38 may be embodied as any number of separate databases, file folders, file storage locations with associated look-up tables, flat files, or the like. In addition, the database 38 may include any number of storage devices for storing any number of individual databases that form the database 38. Although illustrated as separate from the server 12 in the illustrative embodiment of FIG. 1, in some embodiments, the database 38, or a portion thereof, may form a portion of the server 12. The communication link 40 may be embodied as any type of communication link capable of providing communication between the server 12 and the database 38. For example, the communication link 40 may be embodied as any number of cables, wires, fiber optic cables, wireless signals, and/or the like.

The educational institution networks 14 may be embodied as any type of networks capable of communicating with the server 12 via the network 18. For example, the educational institution networks 14 may be embodied as a wide area networks (WAN), a local area networks (LAN), wireless WAN or LAN networks, or the like and may include any number of devices for providing such communication such as routers, switches, computers, communication links, and the like. Typically each educational institution (e.g., each university) will include one or more educational institution networks 14 to link any number of computers and other devices to each other, as well as providing a gateway from such computer to the network 18. As such, each educational institution networks 14 may include any number of remote clients 42. The remote clients 42 may be embodied as any type of computer or computing device capable of communicating with the server 12 via the educational institution network 14 and the network 18. For example, the remote client(s) 42 may be embodied as a typical desktop or laptop computer equipped with a display screen, keyboard, and other devices and circuitry typically found in a desktop and/or laptop computer.

Each of the educational institution networks 14 also includes an educational course database 44. The database 44 may be embodied as any type of database capable of storing educational course data such as what courses are offered, description of the courses, professors teaching the courses, textbooks used in the courses, and the like. For example, the database 44 may be embodied as any number of separate databases, file folders, file storage locations with associated look-up tables, flat files, or the like. In addition, the database 44 may include any number of storage devices for storing any number of individual databases that form the database 44.

The system 10 also may include any number of remote clients 16, which are located separate from the educational institution networks 14. For example, the remote clients 16 may be the personal computers of students and located in the student's house or residence, owned and operated by separate companies such as Internet café companies, or otherwise do not form a portion of the networks 14. The remote clients 16 are similar to the remote clients 42 of the educational institution networks 14 and may be embodied as any type of computer or computing device capable of communicating with the server 12 via the network 18. For example, the remote client(s) 16 may be embodied as a typical desktop or laptop computer equipped with a display screen, keyboard, and other devices and circuitry typically found in a desktop and/or laptop computer.

It should be appreciated that although in the illustrative embodiment of FIG. 1 the system 10 includes three educational institution networks 14 and three remote clients 16, the system 10 may include any number of educational institution networks 14 and remote clients 16 in other embodiments. In addition, although the system 10 illustratively includes only a single server 12, it should be appreciated that in other embodiments any number of servers 12 may be used to perform the functions described herein. For example, several servers 12 may be communicatively coupled to each other but distributed across a geographical area to thereby improve the overall response of the servers 12.

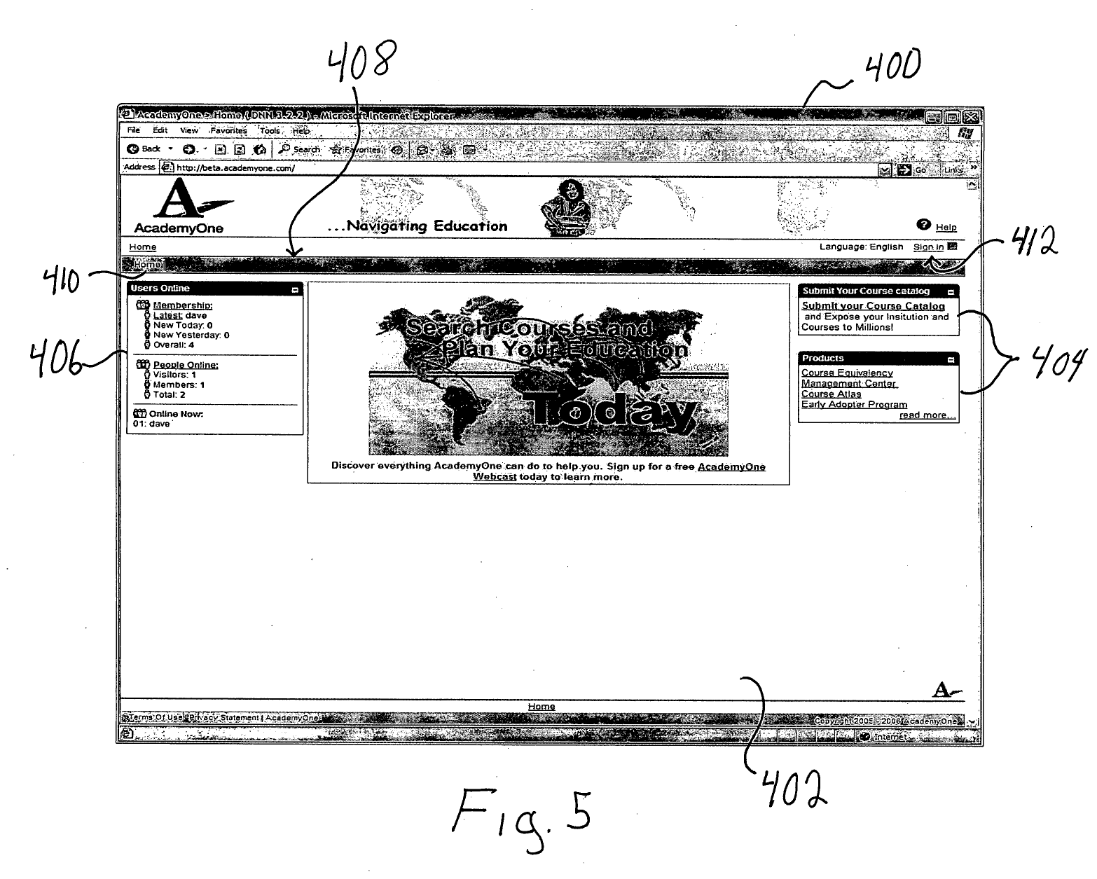

In operation, the system 10 may be used to review, determine, and/or establish educational course equivalencies between a number of educational institutions. To do so, the system 12 may be accessed by the remote clients 16, 42 via the network 18. As illustrated in FIG. 5, when accessed, a user interface 400 is transmitted from the server 12 to the remote clients 16, 42. The user of the remote clients 16, 42 may interact with user interface 400 to access data from and/or submit data to the server 12. The user interface 400 includes a background panel 402 where information may be presented to the user, “quick link” panels 404 wherein direct links to features and information of the user interface 400 are accessible, and a control panel 408 whereon a number of selectable “buttons” 410 are displayed and accessible while interacting with the user interface 400. For example, a “Home” button 410 may be selected by the user to return to the homepage of the user interface 400.

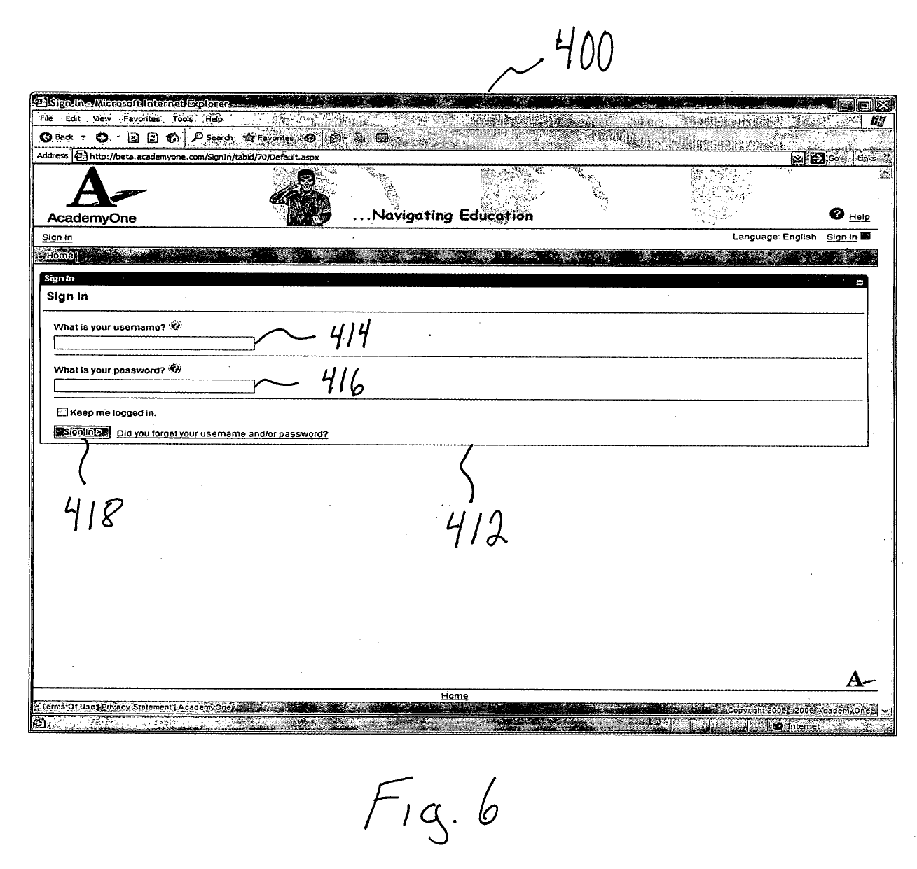

The user interface 400 also includes a “sign in” button 412 selectable by the user to login and thereby access functionality of the user interface 400. Once selected, the user is presented with a login panel 412 as illustrated in FIG. 6. The login panel 412 includes a username data cell 414 and a password data cell 416. To login, the user may type their username and password in the data cells 414, 416 and then select a “sign in” button 418. Once the user selects the button 418, the information supplied via the data cells 414, 416 is transmitted to the server 12 via the network 18. In response, the server 12 determines the validity of the username and password and the identity of the user. The server 12 may, for example, compare the supplied username and password to a username and password stored in the database 38. In some embodiments, the number and type of functions available to the user is determined based on the identity of the user. For example, if the user is a student, only the functions related to educational course viewing may be available. However, if the user is an authorized personnel of an educational institution, advanced functions such as the ability to set and view course equivalencies may be available.

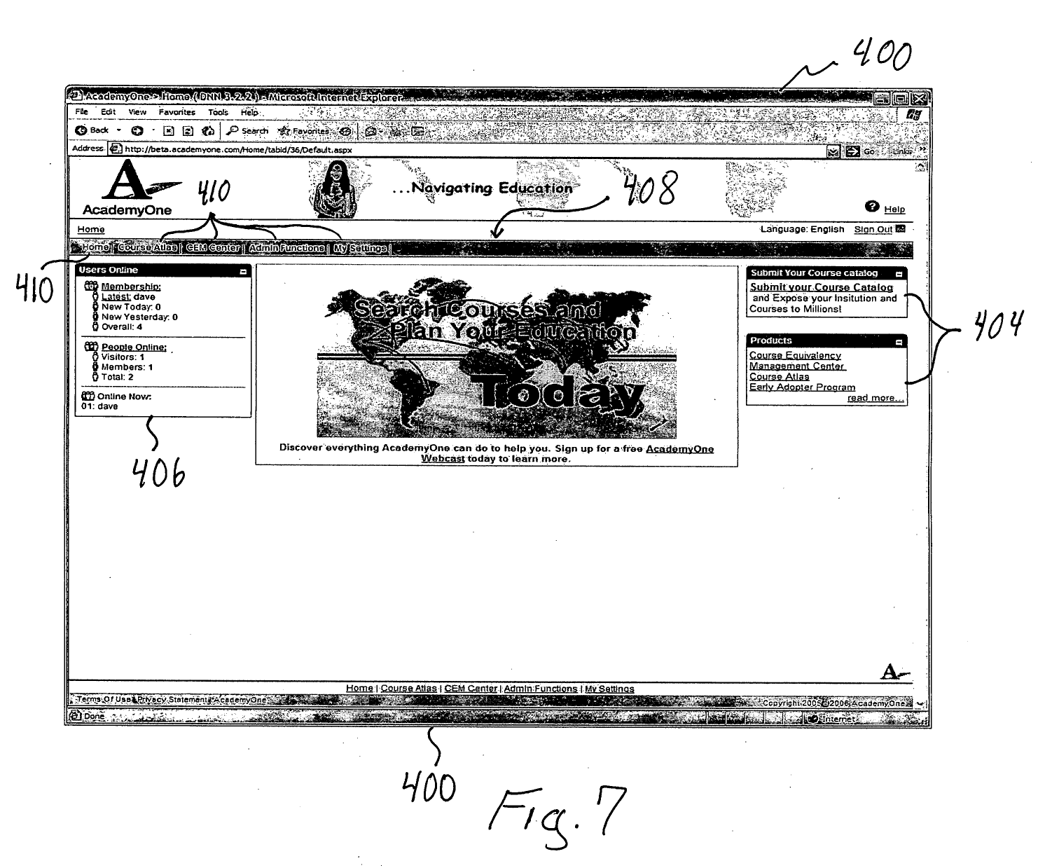

Once the user has entered a username and password and the server 12 determines the validity of the password and the user's identity, a number of additional buttons 410 are displayed to the user on the control panel 408 as illustrated in FIG. 7. As discussed above, the particular types of buttons 410 available to the user may be determined based on the identity of the user. One illustrative control panel 408 includes a “Home” button 410, a “Course atlas” button 410, a “Course Equivalency Management Center” button 410, an “Administration Functions” button 410, and a “My Settings” button 410. The user may select any one of the buttons to access various functionality of the system 10. For example, the user may select the “Course Atlas” button 410 to perform a course search for course equivalencies to an educational course of interest based on course data submitted by the user.

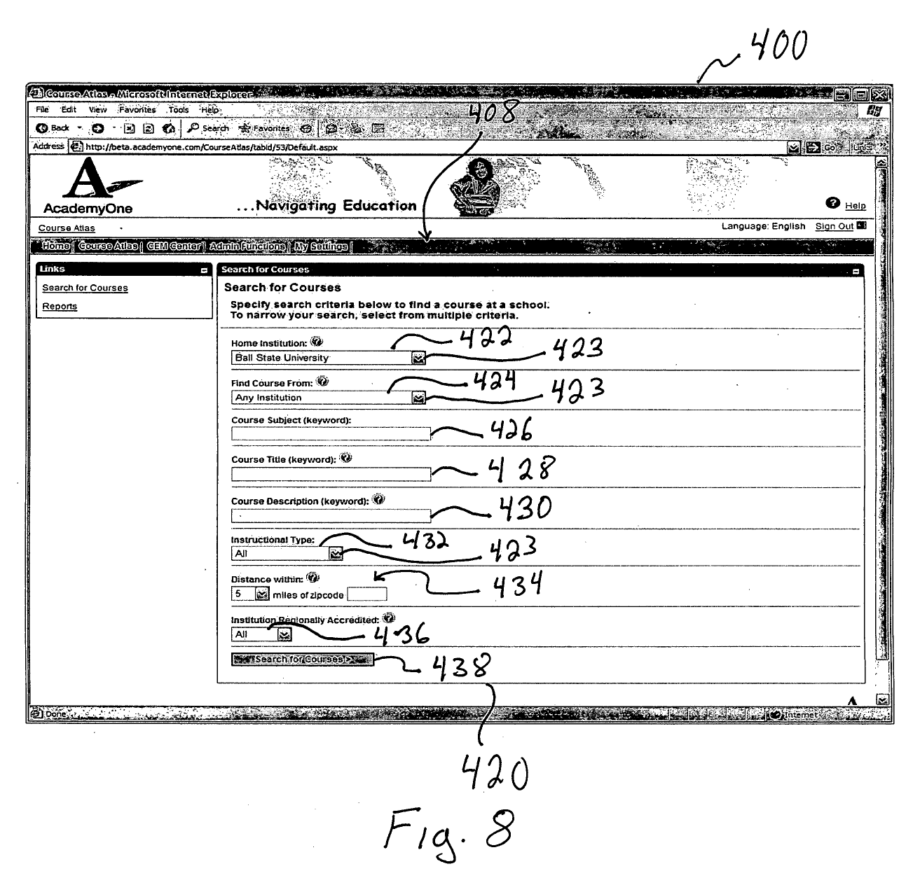

In response to the course atlas request selected by the user, the server 12 is configured to execute an algorithm 100 for reviewing course equivalencies as illustrated in FIG. 2. The algorithm 100 beings with a process step 102 in which course identification data is received from the remote client 16, 42. To do so, a course identification data panel 420, as illustrated in FIG. 8, is transmitted to the remote client 16, 42 via the network 18 and displayed to the user on the user interface 400. The user may use the panel 420 to supply course data to the server. 12 that identifies the educational course of which the user desires to view the equivalent courses. For example, as illustrated in FIG. 8, the panel 420 includes a data entry cell 422 wherein the user may select his/her home educational institution. The user may type in the name of the home educational institution or, alternatively, may select a drop-down button 423 to cause a menu of educational institutions to be displayed. If so, the user may simply select the desired home educational institution from the drop down menu.

The user may also enter or select the desired educational institutions from which the equivalent courses should be displayed via a data entry cell 424. To broaden the user's search, the user may elect to review the equivalent educational courses from all the educational institutions available from the server 12. The educational course subject, course title, and/or keywords identifying the educational course may be entered or selected from data cells 426, 428, and 430, respectively. Additionally, the instructional type may be entered or selected from a data cell 432 respectively. If desired, the user may limit the distance from a predetermined zip code of the educational intuitions to search for educational course equivalents via data cells 434. In this way, the user can ensure that any educational course equivalents found by the server 12 will be within a suitable distance such that the student may attend the equivalent course if so desired. Further, the user can select to view only course equivalents of those educational intuitions that are regionally accredited by selecting or entering such data in the data cell 436.

Once the course identification data has been entered into course identification data panel 420, the user may select a “Search” button 438 to transmit the course identification data to the server 12. The course identification data displayed in FIG. 8 is but one embodiment of the possible course identification data that may be submitted by the user. In other embodiments, additional or less educational course identification data may be used.

Referring back to FIG. 2, once the course identification data has been received from client 16, 42, the server 12 retrieves course equivalency data from the database 38 in process step 104. The course equivalency data may include data identifying educational courses offered by other educational institutions that are accepted by the user's home educational institution as an equivalent course for the educational course selected by the user. Additionally, the course equivalency data may include educational courses offered by other educational institutions that are accepted by the user's home educational institution as an equivalent course for other educational courses offered by the user's home educational institution. Further, the course equivalency data may include educational courses offered by other educational institutions that generally relate to the educational course identification data submitted by the user. To determine such course equivalency data, the server 12 may perform a search on the database 38 using any suitable searching algorithm based on the educational course identification data. As such, it should be appreciated that the number and type of courses retrieved from the database 38 may depend on the selectively of the educational course identification data supplied by the user and received by the server 12 in process step 102.

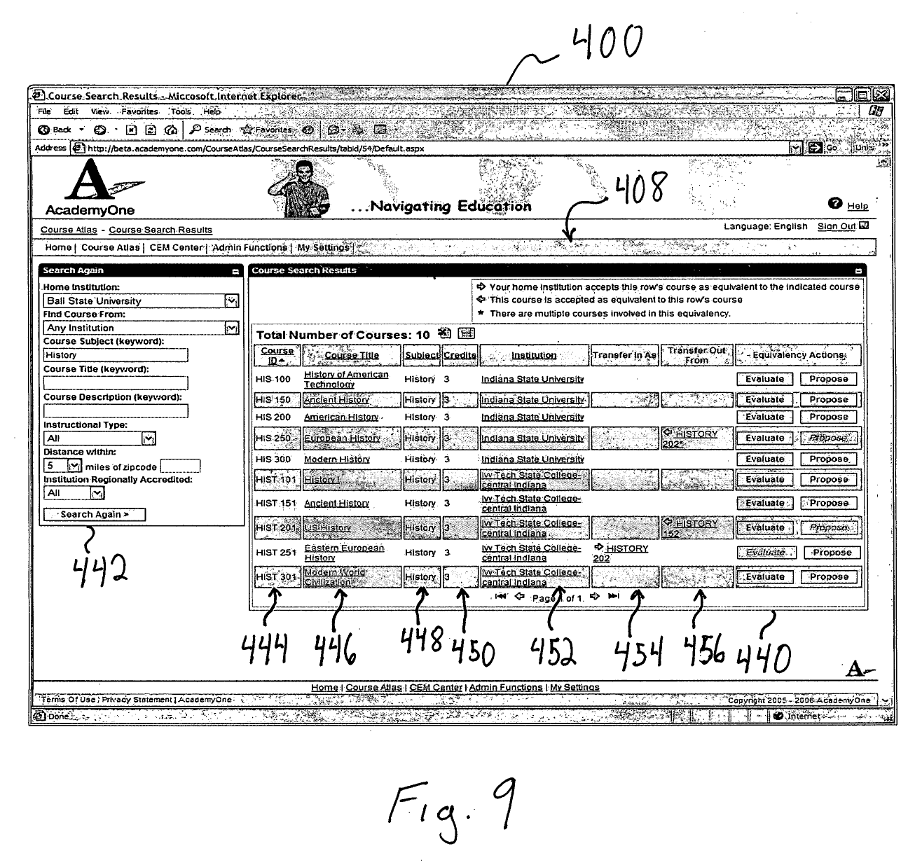

Once the course equivalency data is retrieve in process step 104, the course equivalency data is transmitted to the remote client 16, 42 and displayed to the user thereon. For example, as illustrated in FIG. 9, a course equivalency panel 440 may be displayed to the user on the user interface 400. The course equivalency panel 440 includes a “Course ID” column 444 and a “Course Title” column 446 wherein the course identifier used by the relevant educational institution and the course name are displayed. The course equivalency panel 440 also includes a “Subject” column 448, a “Credits” column 450, and an “Institution” column 452. The subject of the relevant course is listed in the “Subject” column 448. The number of credit hours of the relevant course is listed in the “Credits” column 450 and the name of the institution offering the relevant educational course is listed in the “Institution” column 452. The course equivalency panel 440 also includes a “Transfer In As” column 454 and a “Transfer Out From” column 456. Educational course equivalency data is displayed in the columns 454, 456. For example, if the course or combination of courses listed in the “Course Title” column 446 is accepted by the user's home institution as an equivalent course, the equivalent course offered by the user's home institution is listed in the “Transfer In As” column 454. Additionally or alternatively, a course or combination of courses offered by the user's home educational institution that is accepted by the educational institution listed in the “Institution” column as an equivalent course to the educational course listed in the “Course Title” column 446, such course or combination of courses is listed in the “Transfer Out From” column 456. Additionally, indicia of the course equivalency of the relevant course, such as arrows, buttons, or the like, may be displayed in the columns 454, 456. For example, if the relevant course is accepted as an equivalent course to a course offered by the user's home educational institution, a single ended arrow directed toward a course ID of the home educational institution course may be displayed in the column 454. If the home educational institution course is accepted by the educational institution offering the relevant course as an equivalent course, the arrow may be embodied as a single ended arrow directed out from the course ID of the home educational institution course. However, in other embodiments, other indicia may be used to indicate to the user the course equivalency of each course listed in the course equivalency panel 440.

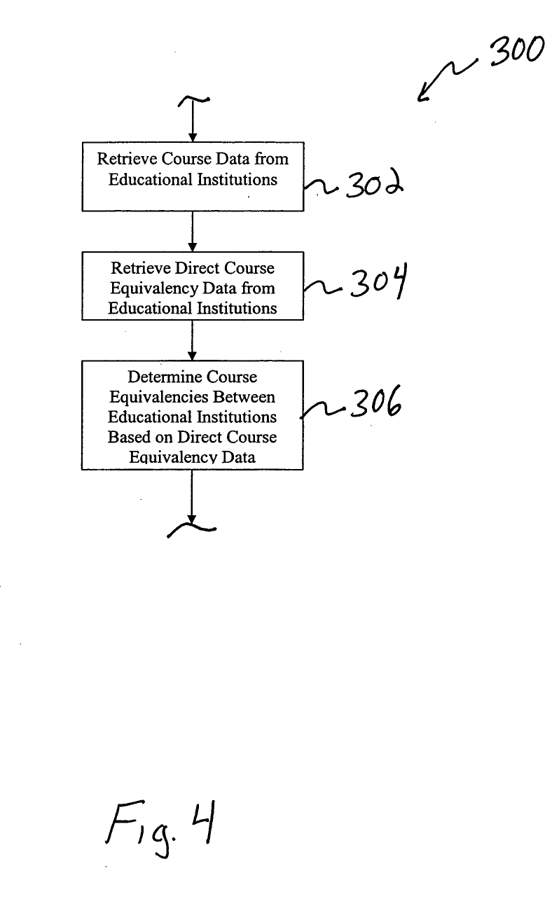

At any time while reviewing the educational courses displayed on the course equivalency panel 440, the user may request additional course information about any one of the listed educational courses by, for example, selecting the course title of the desired course from the panel 440. To do so, the server 12 determines if the user desires to view course information in process step 108. If so, the algorithm 100 advances to process step 110 wherein the course information for the selected educational course is retrieved from the database 38. In process step 112, the course information is transmitted to the remote client 16, 42 for display to the user. The course information may be any type of information related to the selected course. For example, the course information may include the course description as provided by the educational institution offering the educational course. As discussed in more detail below in regard to FIG. 4, the course information may be obtained by the server 12 from the database 44 of the relevant educational institution network 14 in a manual or automated manner such that the accuracy of the course information is maintained.

Once the user has reviewed the course information, the server 12 determines if the current course search is complete in process step 114. If not, the user may select another course to review the course information of the newly selected course. Alternatively, if the current course search is complete, the user may perform a new course search by entering new course identification data in a course identification panel 442 displayed on the user interface 400.

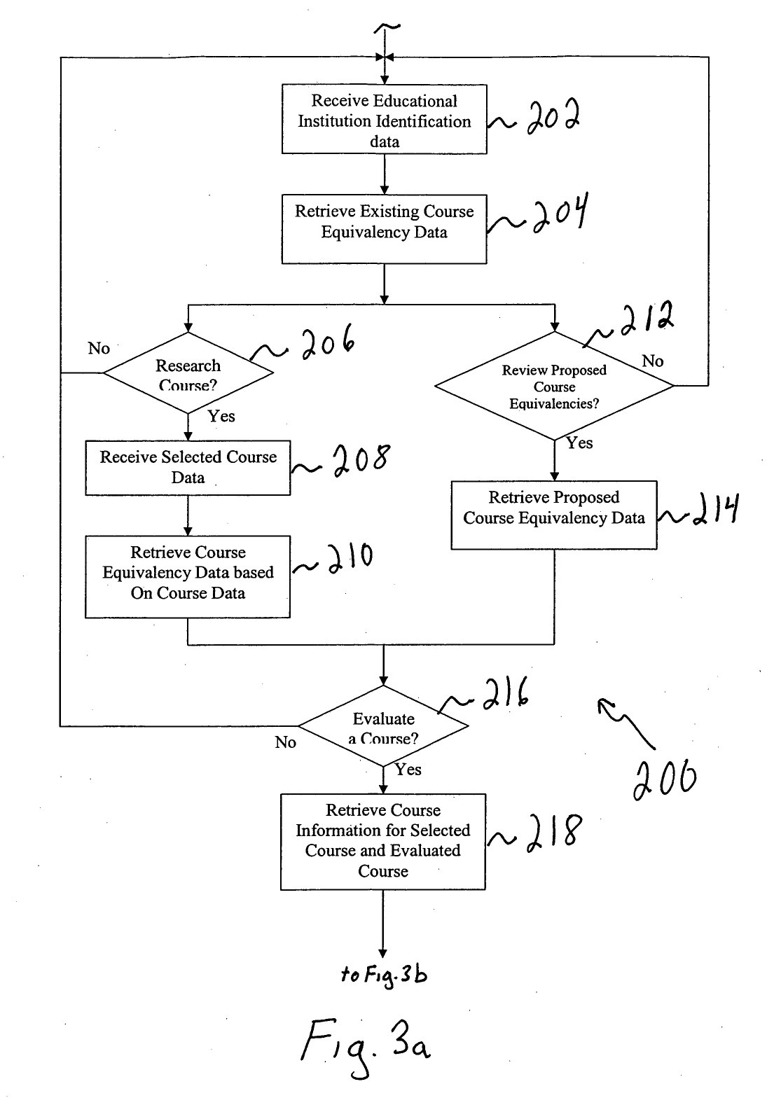

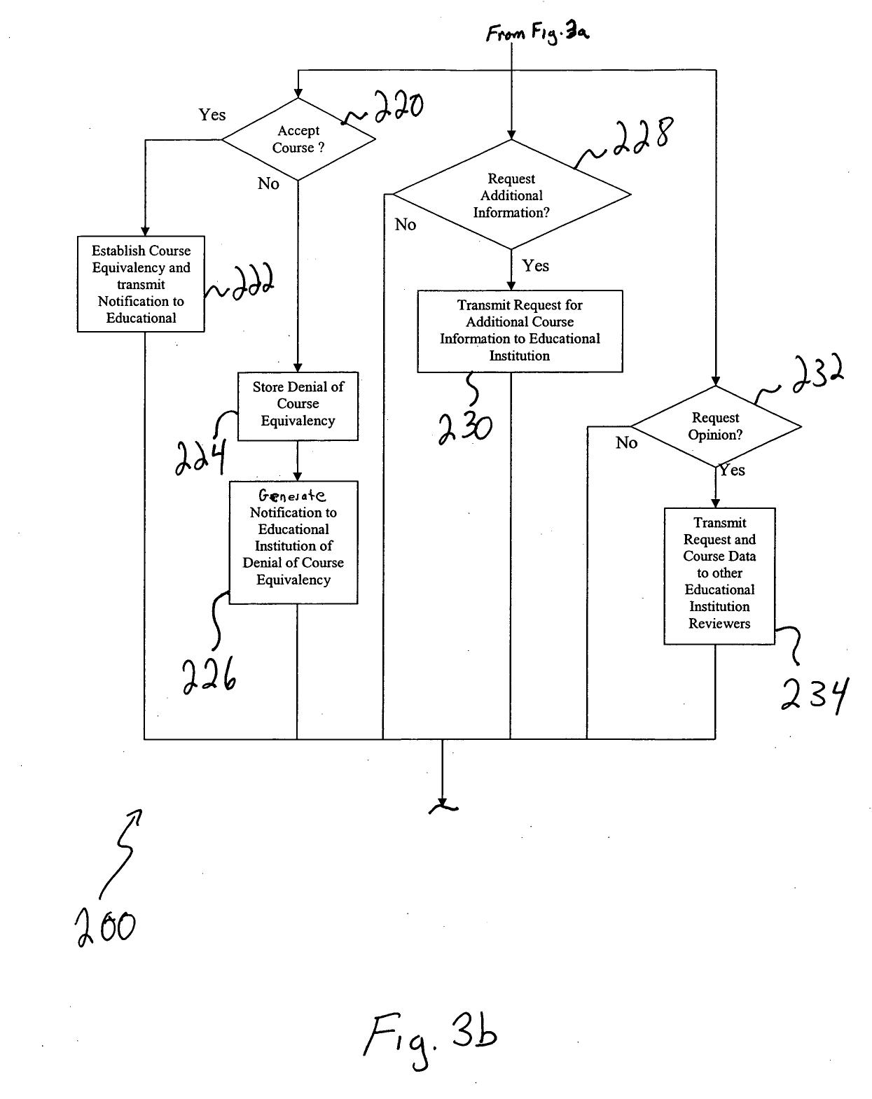

Referring now to FIG. 3, the system 10 may also be used to review and/or establish course equivalencies between one or more educational courses of a home educational institution (e.g., the user's educational institution) and one or more educational courses of one or more other educational institutions. To do so, the server 12 may execute an algorithm 200 for managing educational courses as illustrated in FIG. 3. The algorithm 200 begins with a process step 202 in which educational institutional identification data is received from one of the clients 42 of the network 14 of the home educational institution. The educational institutional identification data may be embodied as any type of data capable of identifying the educational institution such as the educational institution's name, identification number, account number, or the like. In addition, to restrict the ability to establish and/or review course equivalencies to those members of the staff of educational institution responsible for such duties, a password may also be required. For example, the user may select the “Course Equivalency Management Center” button 410 from the control panel 408. In response, the server 12 may be configured to verify that the user, as identified by the user identification data, is authorized to interact with the course equivalency manager. In addition, based on the user identification data, the server 12 may determine the identity of the educational institution that the user is affiliated with and which course equivalencies the user may be authorized to view, modify, and/or establish. Additionally, in some embodiments, an additional password or other level of security may be required to access the functionality of the course equivalency manager via the “Course Equivalency Manager Center” button 410

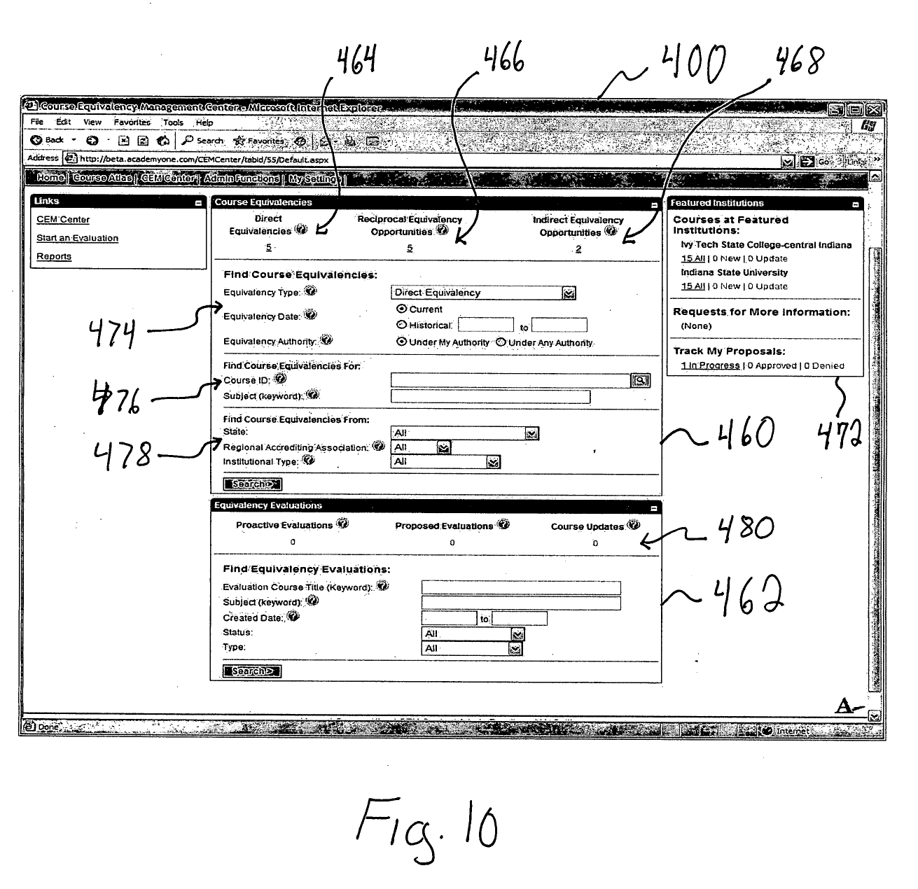

Once the educational institution identification data has been received by the server 12 in process step 202, any existing course equivalency data for the home educational institution is retrieved and transmitted to the client 42 for display to the user in process step 204. For example, as illustrated in FIG. 10, a course equivalency opportunities panel 460, a course equivalency status panel 462, and an overview panel 472 may be transmitted from the server 12 to the client 42 and displayed to the user.

The course equivalency opportunities panel 460 identifies the number of direct equivalencies 464, reciprocal equivalencies 466, and indirect equivalencies 468 of the user's home educational institution. A direct equivalency is indicative of an educational course offered from another educational institution that is accepted by the user's home educational institution as an equivalent course to a course offered by the user's home educational institution.

A reciprocal equivalency is indicative of a course offered by another educational institution wherein the other educational institution has determined that a course offered by the user's home educational institution is equivalent to such course. As such, the course offered by the other educational institution may be an equivalent course to the course offered by the user's home institution (i.e., if A=B, then B=A).

An indirect equivalency is indicative of a first educational course offered from a first educational institution that is accepted by a second educational institution as an equivalent course to a second educational course offered by the second educational institution and wherein the user's home educational institution accepts the second educational course as an equivalent course to a course offered by the user's home educational institution. As such, the indirect equivalency indicates the first educational course may be acceptable by the user's home educational institution as an equivalent course to the course offered by the user's home educational institution. That is, for example, if educational course A is an equivalent course to educational course B and educational course B is an equivalent course to educational course C, then educational course A may also be an equivalent course to educational course C (i.e., if A=B and B=C, then A=C). As such, it should be appreciated that any number of indirect relationships may be involved to generate a single indirect equivalency (e.g., if A=B, B=C, and C=D, then A=D, etc.).

It should be appreciated that the indirect and the reciprocal equivalencies are equivalency opportunities that have not yet been accepted or denied by the user's home educational institution. As such, unlike direct equivalencies, no course equivalency exists yet for the listed indirect and the reciprocal equivalencies. However, as discussed in detail below, the user may select any one of these equivalencies to evaluate the equivalencies and thereby deny or accept it as discussed in more detail below in regard to process step 220.

Any of the different types of equivalencies (i.e., direct, indirect, and reciprocal) may be presented as a one-to-one equivalency, a one-to-many equivalency, a many-to-one equivalency, or a many-to-many equivalency. A one-to-one equivalency is a course equivalency wherein a single course offered by another educational institution is directly, indirectly, reciprocally, or otherwise potentially equivalent to a single course offered by the user's home institution. A one-to-many equivalency is a course equivalency wherein two or more courses offered by another educational institution are in combination directly, indirectly, reciprocally, or otherwise potentially equivalent to a single course offered by the user's home educational institution. That is, the combination of courses B and C may be equivalent to course A (e.g., A=(B+C)). For example, the user's home educational institution may offer a chemistry 101 course, which may include both a three credit hour lecture and a one credit hour lab. Another educational institution may offer a chemistry 101 course that is only a three credit hour lecture and also offer a chemistry 102 course that is only a one credit hour lab. In such a case, the chemistry 101 and 102 courses offered by the second educational institution may be equivalent (via a one-to-many equivalency) to the chemistry 101 course offered by the user's home educational institution. Similarly, a many-to-one equivalency is a course equivalency wherein a single course offered by another educational institution is directly, indirectly, reciprocally, or otherwise potentially equivalent to a combination of two or more courses offered by the user's home educational institution. That is, course C is equivalent to the combination of courses A and B (e.g., A=(B+C)). In the case of one-to-many and many-to-one equivalencies, each course of the combination of courses used to identify the equivalency may be displayed to the user on, for example, the course equivalency panel 440 of the user interface 400.

The course equivalency data displayed in the course equivalency opportunities 460 may be determined by the server 12 in an automated manner in some embodiments. To do so, the server 12 may execute an algorithm 300 for determining course equivalencies as illustrated in FIG. 4. The algorithm 300 begins with a process step 302 in which course data is retrieved from the database 44 of each educational institution network 14. The course data may include identification data, course description, and the like. To do so, in some embodiments, the server 12 may be configured to communicate with the individual networks 14 on a periodic basis to access the information from the relative database 44. As such, if the course data has been updated by the relative educational institution, the server 14 retrieves the updated information to thereby maintain the course data, such as the course description, up to date in the database 38.

In process step 304, the server 12 also retrieves any direct course equivalencies that the educational institutions have pre-established. That is, for example, if the educational institution has already established that it will accept a course from another educational institution as an equivalent course to a course provided by the educational institution; such course equivalency data is retrieved and stored in the database 38.

Subsequently, in process step 306, the server 12 determines any possible course equivalencies between all of the educational institutions based on the direct equivalencies retrieved in process step 304 and/or any other equivalencies (direct, indirect, reciprocal, or potential) already stored in the database 38 for each educational course stored in the database 38. As such, the server 12 is configured to determine if a particular course from an educational institution has any direct equivalencies, indirect equivalencies, reciprocal equivalencies, and/or potential equivalencies based on the data retrieved in steps 302 and/or 304 and/or data already stored in the database 38.

Referring back to FIG. 10, the course equivalency opportunities panel 460 also includes a several course research panels 474, 476, and 478. The research panels 474, 476, and 478 may be used by the user to search for course equivalencies using various types of course related data submitted by the user. For example, the course research panel 474 may be used by the user to perform a course equivalency search based on equivalency type, date, and authority. The course research panel 476 may be used by the user to perform a course equivalencies search based on the course ID, subject matter, and/or keywords. Additionally, the course research panel 478 may be used by the user to perform a course equivalencies search based on identification data of educational institutions such as location, regional accrediting association, and the institutional type. As such, the course related data submitted by the user may be any type of data usable by the server 12 to search for course equivalencies based thereon.

The course equivalency status panel 462 includes a course equivalency status summary sub-panel 480. The number of educational course evaluations and updates awaiting action are listed in the sub-panel 480. For example, the number of proactive evaluations (i.e., educational course evaluations requested by the user) and proposed evaluations (i.e., educational course evaluations requested of the user) are listed in the sub-panel 480. Additionally, the number of courses having updated information is listed in the sub-panel 480. The user may investigate any such courses further by selecting the relevant number displayed on the sub-panel 480 as discussed in further detail below in regard to process step 212. Further, the user may search for course equivalency evaluations via a search sub-panel 482. The user may perform such search based on information such as the course title, subject matter, the date of the evaluation, the status of the evaluation, and/or the type of evaluation.

Referring back to FIG. 3, once the user has reviewed the existing course equivalency data, the server 12 determines if the user desires to research possible equivalencies for an educational course offered by the home educational institution (i.e., the educational institution of the user) in process step 206. Contemporaneously, the server 12 determines if the user desires to review any of the proposed course equivalencies for the home educational institution in process step 214.

Referring to process step 206, the user may request to research possible equivalencies for an educational course offered by the user's home educational institution by entering the applicable course data into one or more of the course research sub-panels 474, 476, and/or 478. The course data may be embodied as any type of data on which course equivalency data may be searched. For example, the course data may include a course ID, a course title, keywords, names of educational institution, locations of the educational institution, and/or the like. The server 12 receives such course data (e.g., the course ID) in process step 208. Subsequently, in process step 210, the server 12 retrieves any course equivalency data from the database 38 based on the search criteria entered in the sub-panels 474, 476, and/or 478. The course equivalency data is subsequently transmitted to the remote client 42 and displayed to the user thereon.

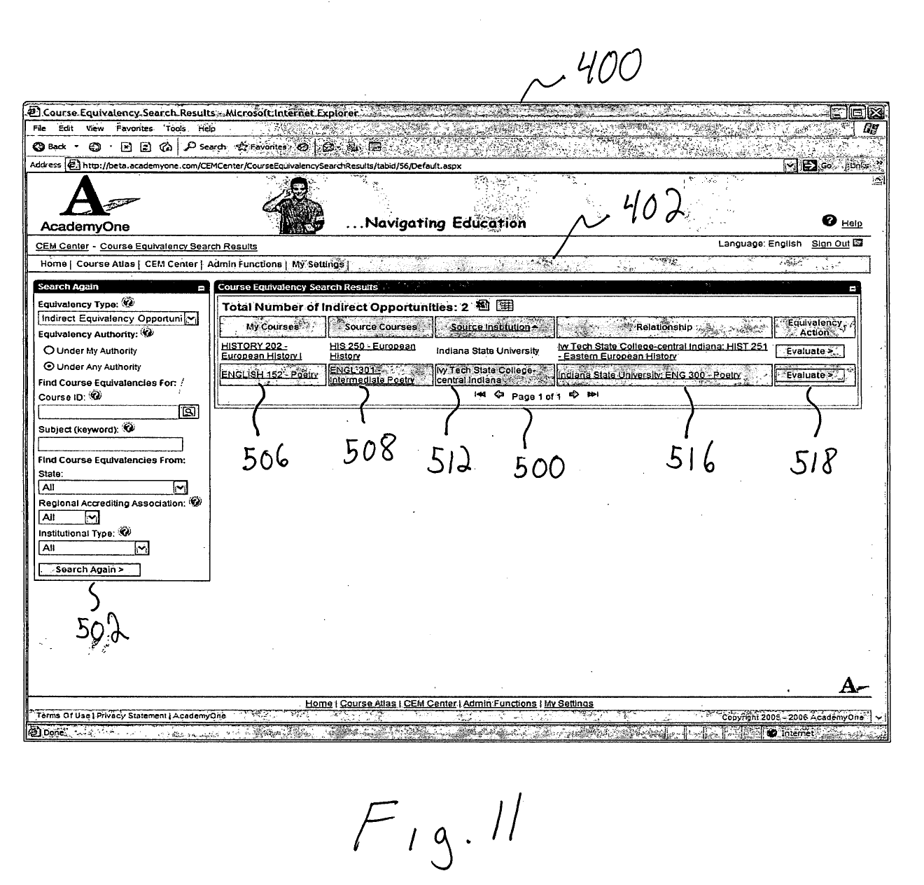

For example, as illustrated in FIG. 11, a course equivalency result panel 500 and a course search panel 502 may be displayed to the user on the remote client 42. The course search panel 502 displays the course related data supplied by the user to perform the present course equivalency search. Additionally, the course search panel 502 may be used by the user to perform an additional course equivalency search by entering the applicable course related data into the search panel 502.

The course equivalency result panel 500 is similar to the course equivalency panel 440 illustrated in FIG. 9. The course equivalency result panel 504 includes a “My Courses” column 506, a “Source Courses” column 508, and a “Source Institution” column 512. The course ID and course title of the educational course(s) offered by the user's home institution is displayed in the “My Courses” column 506. The course ID and title of the educational course(s) offered by another educational institution that is a potential or possible equivalent course to the educational course(s) listed in column 506 is listed in the “Source Courses” column 508. The name of the educational institution offering the educational course or courses listed in column 508 is listed in column 512. The course equivalency result panel 500 also includes a “Relationship” column 516 wherein educational course equivalency data for each possible equivalent course is listed for review by the user. For example, if the equivalency relationship between the courses listed in columns 506 and 508 is an indirect equivalency, then the educational course or courses used to establish the indirect equivalency relationship is displayed in the “Relationship” column 516. The course equivalency result panel 500 also includes an evaluate button 518 for each possible equivalent course such that the user may request an evaluation of any one of the possible equivalent courses as discussed in more detail below in regard to process step 216.

Referring back to process step 212, the server also determines if the user desires to review any of the proposed course equivalencies (i.e., indirect equivalencies, and/or reciprocal equivalencies) displayed on the course equivalency opportunities panel 460 as illustrated in FIG. 10. The user may select the type of possible equivalencies to review by selecting the number associated with the reciprocal equivalencies 466 or the indirect equivalencies 468. In response, the server 12 retrieves the course equivalency data of the entire course equivalencies of the course equivalency type selected by the user and transmits such course equivalency data to the remote client 42 for display to the user. The course equivalency data may be displayed to the user via a display screen similar to that illustrated in FIG. 11 and, as such, the user may request to evaluate any of the listed possible course equivalencies as discusses below.

Referring now to process step 216, in this process step the server 12 determines if the user has selected the evaluate button associated with any one of the possible equivalency courses. If so, the algorithm advances to process step 218 wherein course information for the selected course of the user's home educational institution and the course information for the evaluated course are retrieved from the database 38. The course information may include any type of information related to such courses that may help the user in determining whether to accept the evaluated course as an equivalent course such as, for example, the course descriptions and the like.

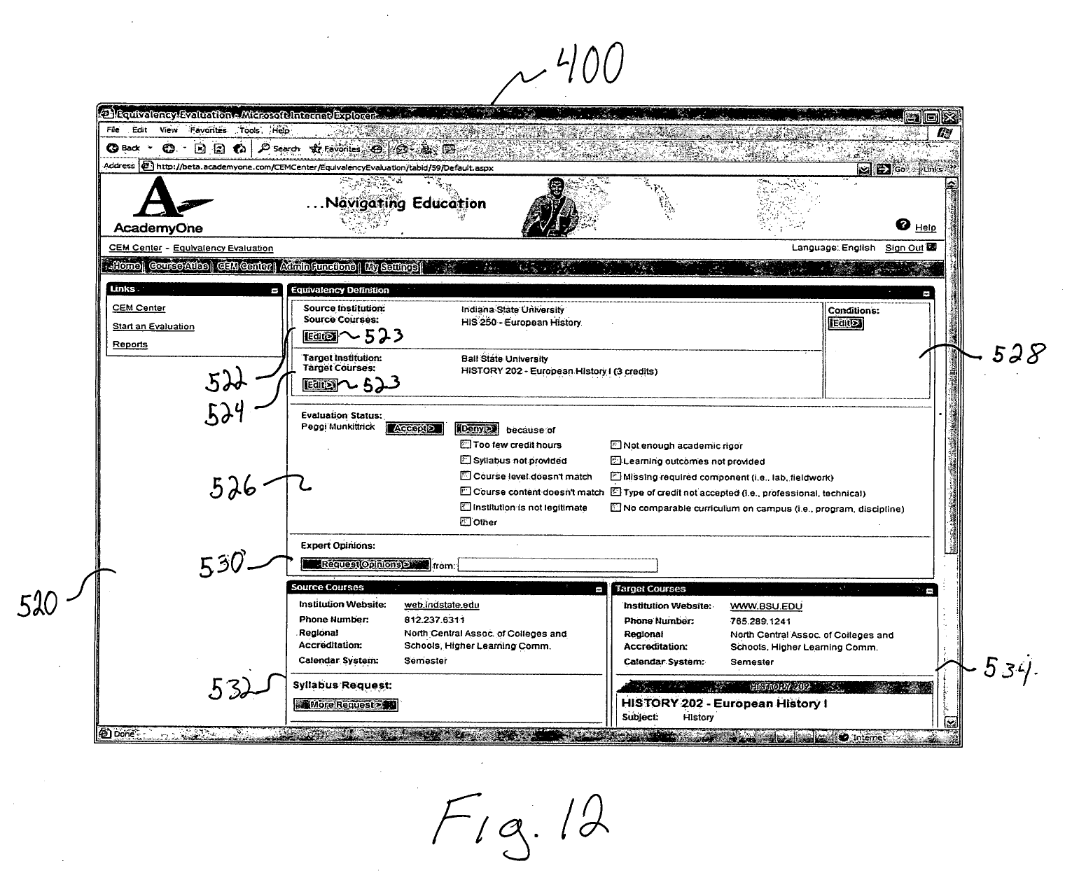

Once the course information has been retrieved in process, the course information is transmitted to the remote clients 42 for display to the user. For example, as illustrated in FIG. 12, a course evaluation panel 520 may be displayed to the user via the user interface 400. The course evaluation panel 520 includes a source course identification panel 522 wherein the educational course offered by another educational institution is displayed and a target course identification panel 524 wherein the educational course offered by the user's home educational institution is displayed. The user may edit the courses displayed in the panels 522, 524 to thereby select a different course by selecting an edit button 523 associated with each panel 522, 524. The course evaluation panel 520 also includes a conditions panel 528 wherein any restrictive conditions on the equivalency of the educational courses displayed in the panels 522, 524 are displayed. Additionally, the evaluation panel 520 includes an information panel 532 wherein the course information, such as the course description, of the course offered by the user's educational institution is displayed and an information panel 532 wherein the course information of the possible equivalency course is displayed such that the user may quickly compare the course descriptions to facilitate their evaluation.

In process step 220, the server 12 determines if the user would like to accept or deny the possible equivalent course as an equivalent course to the course offered by the user's home educational institution. The user may accept or deny the course via an evaluation status panel 526 displayed on the evaluation panel 520 as illustrated in FIG. 12. The user may accept the course by selecting an “accept” button from the evaluation status panel 526 or, alternatively, deny the course by selecting a “deny” button from the evaluation status panel 526. If the course is accepted by the user, the algorithm 200 advances to process step 222. In process step 222, the server 12 establishes a course equivalency (e.g., a direct equivalency) between the two educational courses and stores such course equivalency data in the database 38. The server 12 may also transmit a notification to the other educational institution to notify the other educational institution that the user's home institution has accepted the educational course offered by the other educational institution as an equivalent course to the course offered by the user's home educational institution.

Alternatively, the user may deny the course equivalency by selecting the “deny” button from the evaluation status panel 526 and providing one or more reasons for the denial. The user may provide such reasons by, for example, selecting or otherwise checking a box associated with a listed reason presented to the user on the evaluation status panel 526 as illustrated in FIG. 12. If course is denied by the user, the algorithm 200 advances to process step 224. In process step 224, the server 12 stores the denial of course equivalency between the two educational courses. Next, in process step 226, the server 12 generates a notification to inform the other educational institution that the user's home institution has denied the educational course offered by the other educational institution as an equivalent course to the course offered by the user's home educational institution. The server 12 may provide such notification by transmitting data to the other educational institution network 14 or by presenting such notification to the other educational institution upon the next access of the server 12 by the other educational institution. It should be appreciated that in the illustrative embodiment, course equivalency is described as being determined by a single user. However, in other embodiments, any number of staff members of the home educational institution may be required to evaluate a possible equivalent course before the course is determined to be accepted or denied. In such cases, once one of the users has accepted or denied the possible equivalent course, such information is transmitted to the other users for their consideration. As such, the acceptance or denial of the possible equivalent course is not determined until each authorized member has responded.

Contemporaneously with the determination whether the user has accepted or denied the possible equivalent course in process step 220, the algorithm determines if the user has requested additional information about the possible equivalent course in process step 228. If so, the algorithm 200 advances to process step 230 in which a request for additional information concerning the possible equivalent educational course is transmitted to the other educational institution.

Additionally, contemporaneously with process steps 220 and 228, the server 12 determines if the user has requested an expert opinion such as a fellow member of the user's educational institution, an outside consultant, or the like in process step 232. To do so, the user may enter an email address or other contact information in an expert opinion panel 530 of the evaluation panel 520 and select a “request opinion” button. In response, the algorithm 200 advances to process step 234 in which a request for an opinion and the course information of the possible equivalent course is transmitted to the expert (e.g., a fellow member of the educational institution) via the email address or other contract information provided by the user.

In some embodiments, the server 12 may be configured to periodically send course equivalency data and other related information to the educational institution networks 14. For example, the server 12 may be configured to transmit any updates or changes in course equivalencies, course descriptions, and other information related to the educational courses offered by the various educational institutions. In this way, each of the educational institutions may stay informed of such changes and updates without, for example, directly accessing the server 12 to view course equivalency data. In some embodiments, the server 12 may be configured to transmit the course equivalency data and other related information to the educational institution networks 14 in an automated manner. For example, in one particular embodiment, the server 12 is configured to transmit the course equivalency data and other related information using a Really Simple Syndication (RSS) protocol. In such embodiments, the information may be streamed or otherwise transmitted to the educational institution networks 14 for viewing thereby. If a user of the educational institution networks 14 desires to investigate such information, review course equivalencies, or otherwise interact with the server 12, the user may then access the server 12 as described in detail above in regard to FIGS. 2-10.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the systems and methods described herein. It will be noted that alternative embodiments of the systems and methods of the present disclosure may not include all of the features described yet still benefit from at least some of the advantages of such features. Those of ordinary skill in the art may readily devise their own implementations of the systems and methods that incorporate one or more of the features of the present invention and fall within the spirit and scope of the present disclosure as defined by the appended claims.

1. A method for providing educational course data, the method comprising:
receiving identification data of a first educational course of a first educational institution from a client machine;
retrieving educational course equivalency data from a database based on the identification data; and
transmitting the educational course equivalency data to the client machine.

2. The method of claim 1, wherein receiving identification data comprises receiving a title of the first educational course.

3. The method of claim 1, wherein receiving identification data comprises receiving a course number of the first educational course.

4. The method of claim 1, wherein receiving identification data comprises receiving data indicative of the identity of a second educational institution.

5. The method of claim 1, wherein retrieving educational course equivalency data comprises retrieving identification data of a second educational course of a second educational institution.

6. The method of claim 5, wherein the second educational course is directly equivalent to the first educational course.

7. The method of claim 5, wherein the second educational course is accepted by the first educational institution as an equivalent course to the first educational course.

8. The method of claim 5, wherein the first educational course is accepted by the second educational institution as an equivalent course to the second educational course.

9. The method of claim 5, wherein transmitting the educational course equivalency data comprises transmitting the identification data of the second educational course.

10. The method of claim 5, further comprising:
receiving a request for course information of the second educational course from the client machine;
retrieving the course information from the database based on the request; and
transmitting the course information of the second educational course to the client machine.

11. A method for providing educational course data, the system comprising:
a processor; and
a memory device electrically coupled to the processor, the memory device having stored therein a plurality of instructions, which when executed by the processor, cause the processor to:
receive identification data of a first educational course of a first educational institution from a client machine;
retrieve educational course equivalency data from a database based on the identification data; and
transmit the educational course equivalency data to the client machine.

12. The system of claim 11, wherein to receive identification data comprises to receive a title of the educational course.

13. The system of claim 11, wherein to receive identification data comprises to receive a course number of the educational course.

14. The system of claim 11, wherein to receive identification data comprises to receive data indicative of the identity of a second educational institution.

15. The system of claim 11, wherein to retrieve educational course equivalency data comprises to retrieve identification data of a second educational course of a second educational institution.

16. The system of claim 15, wherein the second educational course is directly equivalent to the first educational course.

17. The system of claim 15, wherein the second educational course is accepted by the first educational institution as an equivalent course to the first educational course.

18. The system of claim 15, wherein the first educational course is accepted by the second educational institution as an equivalent course to the second educational course.

19. The system of claim 15, wherein to transmit the educational course equivalency data comprises to transmit the identification data of the second educational course.

20. The system of claim 15, wherein the plurality of instructions further cause the processor to:
receive a request for course information of the second educational course from the client machine;
retrieve the course information from the database based on the request; and
transmit the course information of the second educational course to the client machine.

21. A method for providing educational course data, the method comprising:
retrieving first identification data of a first educational course of a first educational institution from a database;
retrieving second identification data of a second educational course of a second educational institution from the database; and
transmitting the first identification data and the second identification data to a client machine over a network.

22. The method of claim 21, further comprising:
receiving third identification data of a third educational course of a third educational institution from the client machine; and
wherein the first identification data and the second identification data are retrieved from the database based on the third identification data.

23. The method of claim 22, wherein at least one of the first educational course and the second educational course is directly equivalent to the third educational course.

24. The method of claim 23, wherein at least one of the first educational course and the second educational course is accepted by the third educational institution as an equivalent course to the third educational course.
